(19) United States
(12) Patent Application Publication
(10) Pub. No.: US 2017/0208882 A1
(43) Pub. Date: Jul. 27, 2017

(54) TEXTILE CLOTHING ITEM WITH AT LEAST ONE ABRASION PROTECTION ZONE PROVIDED WITH PROTECTOR ELEMENTS AND A PROCESS FOR ITS PRODUCTION

(71) Applicant: X-TECHNOLOGY SWISS GMBH, Wolleau (CH)

(72) Inventor: Bodo W. LAMBERTZ, Pfaffikon (CH)

(73) Assignee: X-Technology Swiss GmbH, Wolleau (CH)

(21) Appl. No.: 15/328,809

(22) PCT Filed: Jul. 24, 2015
(86) PCT No.: PCT/EP2015/067072

§ 371 Date: Jan. 24, 2017

(30) Foreign Application Priority Data
Jul. 25, 2014 (DE) 10 2014 010 868.6
Jul. 25, 2014 (DE) 20 2014 005 975.6

(51) Int. Cl. A41D 31/00; B29C 39/10; B29C 39/36; A41D 13/02

(52) U.S. Cl. CPC A41D 31/0055; A41D 13/02; B29C 39/10; B29C 39/36; A41D 2600/102; A41D 2600/104; A41D 2500/10; B29K 2913/00; B29K 2509/04

(57) ABSTRACT

In a process for the production of a textile clothing item with at least one abrasion protection zone provided with protector elements, the following steps are provided:
1) Provision of a textile backing layer (1) that is expandable and is provided in the form of a tube open on both sides (1), into which a support element (2) is introduced before the application of the coating material (5), by means of which the tube (1) is pre-extended and stretched free of wrinkles in the abrasion protection zones provided.
2) Provision of a pasty, hardenable coating material (5);
3) Application of a large number of portions of the coating material (5) on a surface of the backing layer for the formation of the protector elements, whereby the portions of the coating material (5) are arranged on the surface in such a way that the portions do not overlap and only a portion of the surface of the backing layer is covered by the coating material (5). A metallic molding plate (10, 20) that contains a large number of concave form cavities (11, 21) for the formation of the protector elements (101), which are filled with the pasty coating mass (5) and which is applied, with its openings, to the tube (1) supported on the support plate (2), is used for that purpose.
4) Hardening of the coating material (5) during the application of temperature for the formation of a large number of hard protector elements on the backing layer.

The invention relates to a textile clothing item with at least one abrasion protection zone provided with protector elements, in which a large number of protector elements are applied at a distance from one another on flat textile materials that consist of a polymer matrix with embedded abrasion-resistant particles.

Moreover, the invention relates to a process for the production of such a textile clothing item with the characteristics of the introductory portion of claim 9.

In the area of motorcycle clothing, protective clothing items that have integrated protectors, such as in accordance with DE 100 14 025 A1, for example, are becoming increasingly prevalent. These protectors, however, are particularly used to brace the vertebral column during crashes in order to prevent spinal fracture. They are only suitable to a limited degree for protection against abrasion injuries, since the body parts exposed during a crash cannot be covered with massive protector elements without restricting the mobility of the rider.

If a motorcyclist, a bicyclist, or a roller skater crashes, then the risk of injury initially turns out to be less than the direct impact on the road surface. The driver of a two-wheeled vehicle or a skater has a relatively high speed relative to the road surface and thereby a high kinetic energy so that, during a crash, he hits the road surface at a sharp angle and then slides over a long stretch over the road surface before being braked by frictional forces.

In addition to the direct mechanical effects, which lead to severe abrasion injuries, the development of heat must also be considered in this phase. With a travelling speed of 60 km/h, a rider weighing 80 kg has a kinetic energy of approximately 11 kJ. During a sliding time after a crash on asphalt or concrete of approximately 3-4 seconds, approximately 3000 W are converted per second, most particularly in the form of heat, until coming to a standstill.

Nevertheless, a controlled sliding of the person crashing along the road surface is the surest possibility for preventing still more severe injuries, provided that the exposed body parts are sufficiently protected with abrasion protection elements. If the sliding process is blocked, however, or if the friction coefficient between the road surface and the clothing of the person is too high, then rollovers can also occur, which entail severe injuries, even if a motorcyclist has not yet been separated from his motorcycle, for example, and the friction coefficient, on the other hand, is then too low and the sliding path after the crash is too long and the danger exists that the person crashing may slide beyond the edge of the road and into the guardrails on the edge of the road, for example.

A clothing item of the type stated above has been described in the DE 20 2011 051 635 U1. This provides, instead of large-surface protector elements that cover endangered body parts over a large surface, a large number of small protector elements which, in a complementary manner, are to be positioned at a small distance from one another, particularly in order to also cover three-dimensional shapes on the body. It is thereby provided, of course, to not only offer protection against abrasion injuries, but also against cutting injuries and the effect of fire. Thus, the textile surface in the protection zone is primarily covered by protector elements and only a very narrow intermediate space remains free. In regard to motorized riders of two-wheeled vehicles, a sufficient removal of heat and sweat might possibly occur in the remaining uncovered zones because of the continuous headwinds,. The remaining uncovered surface areas are too small for the regulation of temperature and moisture when running, motorcycling, or roller-skating. Also, the weight of the protection coating would be too high if all zones that are endangered in these types of sports were to by be protected. Finally, a problem consists in the fact that the protector elements on the outside are relatively sharp-edged. As the result, the gaps between them do, to be sure, remain too small to offer effective protection against cutting . . . and burn injuries. These edges, however, block the rough features of the around and consequently sometimes even increase the risk of injury.

WO 2013/053587 describes textiles with a protective function, in which mixtures of hardenable polymers and abrasion-resistant particles embedded in them are selectively applied to a fabric. The curved protector elements thus designed are applied and distributed over it, so that flat areas remain uncovered between them, and the breathability of the fabric is only slightly restricted. After the application, the polymer should penetrate into upper fabric layers so that an anchoring should be achieved upon drying out. The protective effect, however, is restricted precisely against contact heat for the case of a sliding phase after a crash, because the fabric is, in any event, thin and, because of the protector elements penetrating into deeper fabric layers, only residual layers that are still very thin can still be effective for thermal insulation.

If folds arise in the fabric when it is worn, then, during a crash, these can be present between the road surface and the protector elements below. The danger thereby exists that the protective clothing will tear off, so that the skin is exposed and unprotected. Because of the slight extensibility of the fabric and the slight anchoring depth therein, the protector elements can also tear off from the fabric. Furthermore, it has proven to be difficult to form a large number of uniformly arranged and uniformly formed protector elements from a pasty polymer mixture by means of simple perforated templates.

A first task of the present invention consequently consists of improving a textile clothing item with at least one abrasion protection zone provided with protector elements of the type stated above in such a way that it is not only a more effective abrasion protection of the skin over the entire sliding path up until the complete stopping present but, rather, a specific friction coefficient also exists in the pairing between the surface in the abrasion protection zone of the clothing item and of an asphalt or concrete surface of a road, which permits the sliding of the person along the road surface and prevents subsequent rollovers.

This task is solved, in accordance with the invention, by means of a clothing item with at least one abrasion protection zone provided with protector elements with the characteristics of the protective claim 1.

The interaction of the textile elasticity and the hardness, form and arrangement of the protector elements is essential to the invention.

A value termed the “sliding angle” represents, in connection with the present invention, a value for how a force vector acts on an individual protector element if this strikes an irregularity or a foreign body in the road surface. A “sliding angle” is defined in the present as the angle between the exterior of the textile that supports the protector elements and the tangent that emerges from the average between adjacent protector elements on the textile base, and each abuts tangentially on the protector elements, which are preferably shaped as spherical segments.

The sliding angle is also a value for the angle at which the protector elements on a flat road surface can be positioned in a tilted manner relative to the road surface until the textile area exposed between the protector elements comes into contact with the surface of the textile base.

As the result of the stretching of the textile surface on which the protector elements are applied, the original sliding angle on the clothing item is further reduced upon wearing on the body. The selection of a knitted fabric is particularly advantageous, since highly tear-resistant fibers can be used for the additional protection of the athlete, but this nevertheless permits a clear stretching of the textile surface because of its special process, however. The stretching is, therefore, initially achieved through the extension of the loops of thread and not primarily through a material elasticity of the fibers. This also means that the expansion area is limited to the top until, that is to say, the maximum elongation of the knitted textile is possible, such as up to a maximum of 100%, for example. By that means, the protector elements are prevented from being drawn too far from each other and excessively large exposed flat areas are prevented from being present.

Moreover, the large spacing of fiber and thread in the knitted fabric offers a better possibility for anchoring the protector elements applied.

The clothing item in accordance with the invention has an undersize in relation to its nominal clothing size, so that a first pre-stretching of the main textile body of at least 20% is already achieved upon putting it on. The clothing item thereby lies close to the skin, and the dome-shaped protector elements are positioned precisely along the skin surface. Folds are also prevented, since any possible folds could form starting points that remain firmly attached upon a fall to the ground and thereby tear off the protective clothing item.

In addition to pre-stretching, the textile surface makes possible an additional stretching of at least an additional 20% upon high stressing.

Because of the high pre-stretching, the distance of the protector elements from one another increases and the sliding angle drops. If the fabric additionally expands during a crash, then the sliding angle drops still further.

If the wearer of the clothing item crashes at the high speeds that are common during racing sports, particularly bicycling, then he does not drop vertically onto the road, but instead hits the road surface at a sharp angle because of his mass inertia. It is precisely upon downhill runs that a high speed and additional ground slope is present, so that relatively small impact angles are achieved. After the impact of the body on the road surface, it is necessary, for the prevention of severe injuries, to achieve a braked stopping of the crashing person with a defined friction coefficient between the outside of the clothing item and the road surface, which, however, should not be too abrupt, in order to prevent rollovers.

The person protected with the clothing item in accordance with the invention slides, in the ideal case, along the road surface in such a way that only the summits of the protector elements preferably shaped as spherical segments are applied to the road surface.

Because of the great hardness of the protector elements, particularly those produced from boron carbide, the abrasion is so slight that, after the crash, the protector elements are, to be sure, reduced in their height in the outlet area, but cannot be completely abraded down to the textile base, however. At the same time, the protector elements shaped as spherical segments have a relatively large surface in relation their volume, so that the frictional heat already arising at the point of origin . . . can be irradiated. A transfer of heat into the knitted fabric only takes place slowly, because of the slight thermal conductivity of the knitted textile ground.

In addition, the knitted fabric can be designed clearly thicker in comparison with a woven cloth, without the permeability to air and the thermoregulation being impaired.

Differently from the state of the art, the protective effect described in accordance with the invention is also achieved in accordance with the invention if a quasi-ideal course of a crash on a flat road surface does not occur. It must instead be taken into account, in actual practice, that cracks will cross the road surface or that foreign bodies, such as sand and gravel, which can be clamped between the crashing person and the road surface, will be present on the road surface.

If a protector element in the clothing item in accordance with the invention strikes an irregularity or a crack in the road surface, then it may, in many cases, because of its surfaces and the form of the spherical segments, in connection with the slight sliding angle, nevertheless glide over the obstacle without problem. If individual protector elements should nevertheless catch on the obstacle, the stretching reserve in the textile base comes into play, so that, because of the possibility of the elastic stretching, the additional sliding process of the crashing person at least does not end abruptly. Even if an entire line of protector elements enter into a crack in the road surface, the person is not braked in such a way that a rollover movement will take place immediately. The level of tensile strength of the fibers used can, in connection with the elasticity of the textile ground, lead to the person initially sliding a little bit further, whereby local parts of the textile are stretched. In many cases, the restoring forces are then sufficient to release the blocked protector elements and to restore them to their starting position. If, in the worst case, however, a tearing of the individual protector elements does come about, then at least no sudden braking movements that could lead to rollover events are connected with a failure of individual protector elements. Even upon the loss of individual protector elements, the person crashing can slide further, and is thereby still sufficiently protected by the large number of remaining protector elements.

It is thereby advantageous to position at least one row of elements with a smaller height between two rows of protector elements with the greater height. The contact with the road surface is then initially present in the large elements. If parts of the clothing item are severely bent locally and/or if the prestressing is already very great because the person has selected a too-small clothing size, then the textile areas lying exposed between the larger elements are additionally protected by the at least one additional row of smaller elements. If a large element tears off, then the lower, smaller element remains undamaged and offers a protection for the remainder of the crash phase.

A variation of the sizes can also be provided for those body areas that are very heavily exposed and in which little muscle tissue is present, in order to provide greater protection and to prevent abrasion injuries in deeper skin layers in every case. These include the area of the pelvic bone, the shoulder joints, the shoulder blades, as well as the elbow joints.

It has proven to be particularly advantageous to carry out the arrangement of the protector elements in an undirected, anisotropic form, that is to say, to consciously to prevent grid-shaped arrangements of the protector elements, or to at least prevent a local sub-pattern from repeating over the entire abrasion protection zone. Tearing edges in the material are thereby prevented.

Finally, an adjustment can occur in the arrangement of the protector elements depending on the type of sport for which the clothing item is provided. In a road race, other body parts are affected and more kinetic energy must be reduced in the event of a fall through friction than in a marathon runner who fails at the starting point or in a skier who falls on frozen or hard ground. One additional the task of the present invention consequently consists of improving and facilitating the production of a textile clothing item with at least one abrasion protection zone provided with protector elements.

This task is solved in accordance with the invention by means of a process for the production of a clothing item with at least one abrasion protection zone provided with protector elements with the characteristics of claim 8.

First of all, the use of a textile backing layer that is expandable and present in tubular form is essential to the invention.

The production is facilitated through pre-stretching, since the backing layer, through the support element inserted, such as a support plate, in particular, is applied tautly and solidly to the support element and a slipping is prevented upon the additional processing. Moreover, the protector elements can be applied in such a way that, if it should later be present in use in a way other than in accordance with the invention, a level of extensibility of the textile backing layer of at least 20% is provided. The clothing item formed from that only fulfills its protective function if it is applied to the wearer just as closely as on the support means during production. The clothing item is correspondingly produced with an undersize, depending on the clothing size, whether smaller or larger. The desired pattern of protector elements on the pre-extended backing layer can therefore be produced at the desired distances from one another. After the removal of the support element, the backing layer returns to its original dimension, whereby the distances of the protector elements diminish.

The use of knitwear on the finished clothing item has the advantage that a high value of stretching, up to 100%, can be set. The clothing item is then applied, in every case, against the body free of wrinkles. In addition, the knitwear offers a high permeability to air and has a significantly greater layer thickness in comparison with a fabric. The heat insulation is thereby decisively improved and the anchoring of the protector elements against layers deeper in the fabric is possible, without the protection against the contact heat arising through friction being disadvantageously reduced. The textile backing layer is, in this case, a circular knit tube.

The use of a knitted fabric in the form of a circular knit tube is also advantageous, therefore, because unprotected seam areas on the finished clothing item are prevented and abrasion protection zones can be designed on the entire circumference of a body area. In accordance with the invention, a support plate is preferably inserted into the circular knit tube for that purpose, so that an upper and a lower exposed surface, on which the protector elements can be produced, are formed. Also, the circular knit tube can be handled in sections, since the support plate is removed and the circular knit tube is newly positioned therein.

For the production of a large number of protector elements with a defined conical or spherical segment geometry, it is provided, in accordance with the invention, to use form elements with a large number of concave form cavities. Fiat molding plates are particularly well suited as form elements. Even molding rollers can be used for that purpose, however.

In a first variant of the process in accordance with the invention, a molding plate, which contains a large number of concave form cavities, each of which has a broad base on the surface to be oriented to textile backing layer and a tapered opening on the opposing surface, is preferably used. The molding plate is applied to the surface provided with broad openings of the form cavities to the circular knit tube supported with the support plate or to another expandable textile backing layer, as the case may be. The pasty coating material is then pressed through the narrow openings of the molding plate and downwardly into the form cavities and the molding plate is wiped against the surface provided with the narrow openings. The form cavities can be completely filled and the coating mass can at the same time be pressed into the knitted fabric positioned under the molding plate.

Only in the small upper opening of the form cavity is there air contact with the coating mass, and only there can small sink marks appear. The opening to the upper side of the form cavity is kept very narrow, so that—differently than upon an easily perforated template—only a slight deviation of an ideal geometrical hemispherical form arises through wiping.

One other preferred variant of the process in accordance with the invention likewise provides for the use of a molding plate as a form element with a large number of concave form cavities, although the cavities have no additional opening to the upper side, however. The molding plate is, instead, positioned with the openings directed upwardly and then filled. These form cavities, which are only open on one side, now simply fill with the pasty coating mass and wipe the surface in accordance with the type of baking form, so that sink marks form at the base of the specific cavities. After the overturning of the molding plate and its placement on the tube, a surface connection of the pasty coating mass with the knitted fabric can only occur because of the downwardly moving coating mass, since no pressure could be exerted on the coating mass, . . . and the viscosity of the coating mass would have to be lowered, so that this can thereby be generally able to penetrate into the textile layer. Through that fact, the form stability of the portions still not hardened would thereby be impaired in turn, however, so that the form of the hardened protector elements would not be uniform and would not correspond to the desired geometry. Through wiping, the coating mass would, moreover, be entrained into areas close to the edge around the form cavities provided.

The special feature of the process in accordance with the invention in accordance with this process variation now consists of the fact that an excess of coating mass can be produced in a targeted manner on each form cavity, so that, upon the placement of the molding plate on the circular knit tube, or upon a reversal, this excess is moved into a coating mass in the textile, such as a knitted fabric, for example, and ensures a secure anchoring of the protector elements therein. This excess is provided in very defined form through that fact that, before the filling of the coating material into the form cavities, a thin auxiliary blade plate is applied to the molding plate, the thickness of which, in particular, amounts to less than one fifth the depth of the form cavities and which is provided with recesses. The pattern of holes of the auxiliary blade plate is in agreement with the opening cross-sections of the form cavities on the surface of the molding plate. The filling of the form cavities occurs together with this auxiliary blade plate. Excess coating mass is removed by wiping the upper side of the auxiliary blade plate applied. After that, the auxiliary blade plate is carefully removed and, specifically so, as accurately as possible and in a direction precisely perpendicular to the molding plate. The coating material adjusted to be pasty is now elevated, by the thickness of the auxiliary blade plate, above the surface of the actual molding plate. This projection forms the stated excess of coating mass.

One additional advantageous effect is brought about through the removal of the auxiliary blade plate since, because of the adhesion of the coating mass to the narrow edges of the openings in the auxiliary blade plate, it happens that, upon raising the plate, the edges of the projection of the coating mass are most particularly pulled up and form a funnel form in the center. Edges that are almost sharp-edged therefore form on the coating mass that is correspondingly rigid and set to be freely adjustable, so that, even after pressing on the textile support material and after the hardening out, the protector elements produced in this way have very . . . defined sharp-edged contours of the base. The remaining spherical form of the protector elements also corresponds completely to the form predetermined by the form cavity because, upon the connection of the circular knit tube with the molding plate, the projection is pressed into the fabric, through which a pressure is also applied to the coating mass at the same time, which leads to the fact that the mass is applied to the boundaries of the cavities over its full surface.

The coating mass is then hardened. This can be carried out, depending on the chemical characteristics of the coating mass, by means of a heat treatment, but can also be carried out, for example, through radiating with UV light or chemical hardening through use of a two-component mixture, etc. The hardening preferably occurs through the fact that the compound of the form element and the textile backing layer, such as is, in particular, inserted into the circular knit tube in a hardening oven. After that, the molding plate is removed from the textile backing layer. The textile provided with the protector elements can now be further processed into a clothing item in the known manner.

In order to facilitate the detachment of the protector elements from the cavities, the form cavities are treated with a separating agent, preferably as soon as upon the preparation of the molding plate.

The second preferred embodiment of the process in accordance with the invention, which provides for the use of the auxiliary blade plate, makes it possible to adjust the pasty coating material with a high viscosity, since it does not need to be pressed through a narrow opening, but it can, instead, be pressed in from the broad opening side and into the cavities. Through that fact, the mass is freely movable, even upon short-term influences from the force of gravitation. The molding plates can, therefore, also be applied upon falling and with the openings pointing downwardly. The upper and lower side can consequently be treated at the same time on the textile supported by the support plate, as well as by the circular knit tube, by means of two molding plates.

Because of the great hardness of the protector elements that are produced, in particular, from boron carbide and a hardenable polymers base material, the abrasion is so slight in the outlet area after a crash that the protector elements are reduced in their height . . . but cannot be abraded completely to the textile base, however. At the same time, the protector elements shaped as spherical segments have a relatively large surface in relation to their volume, so that frictional heat sometimes already arising at the point of origin can be radiated.

Because of the slight thermal conductivity, heat transfer inwardly only occurs slowly, particularly upon a knitted textile ground.

The invention is explained in the following in further detail, with reference to the diagrams. In individual terms, the figures show the following:

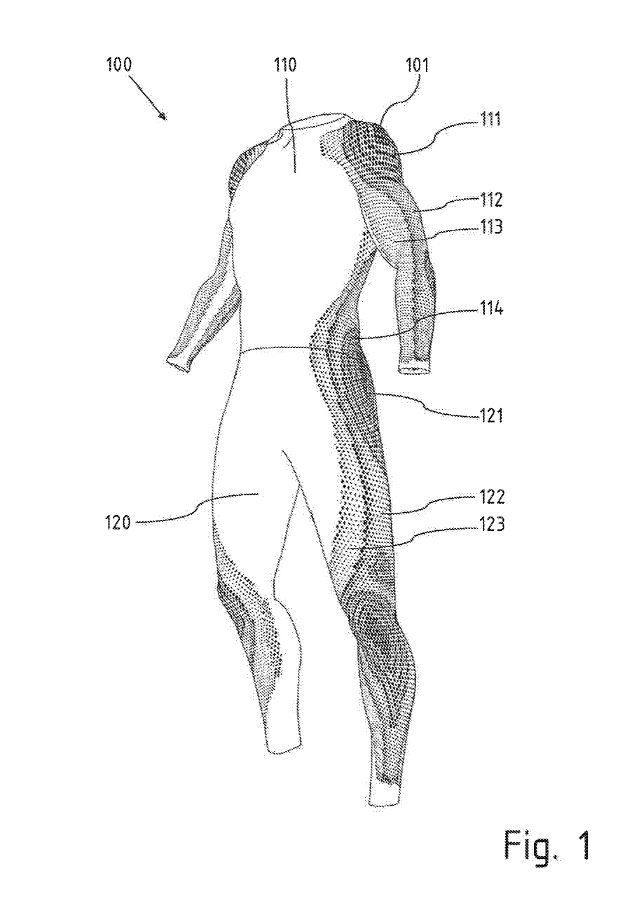

FIG. 1: A clothing item with abrasion protection zones, in a perspective view;

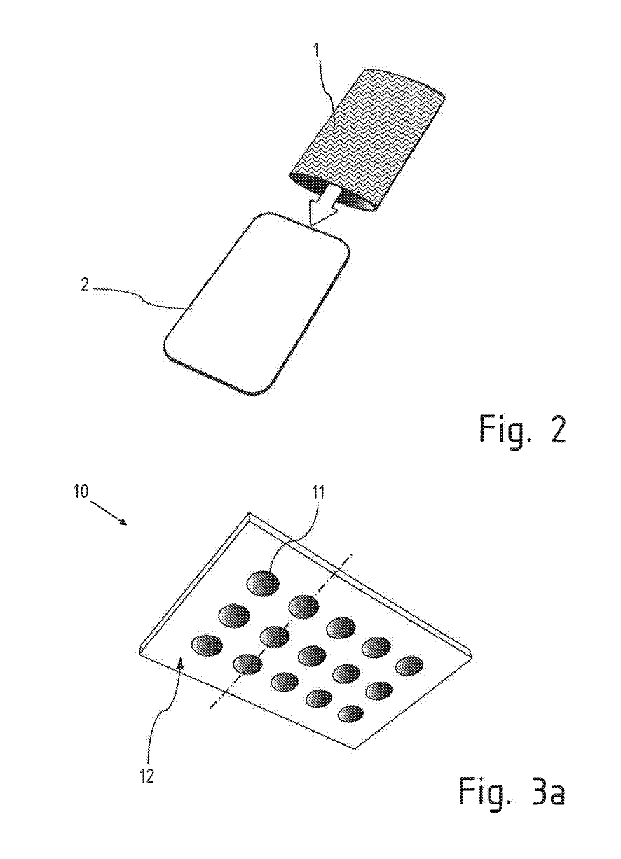

FIG. 2: The preparation of a textile backing layer, in a perspective view;

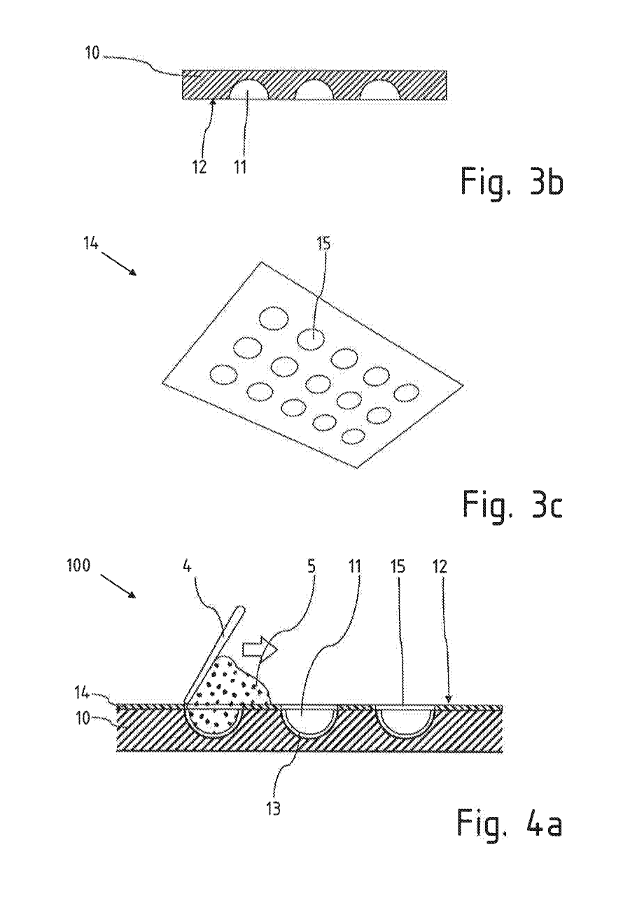

FIG. 3-a: A molding plate in accordance with a first embodiment, in a perspective view from below;

FIG. 3-b: The molding plate in accordance with FIG. 3-a, in a cross-sectional view;

FIG. 3-c: An auxiliary blade plate, in a perspective view;

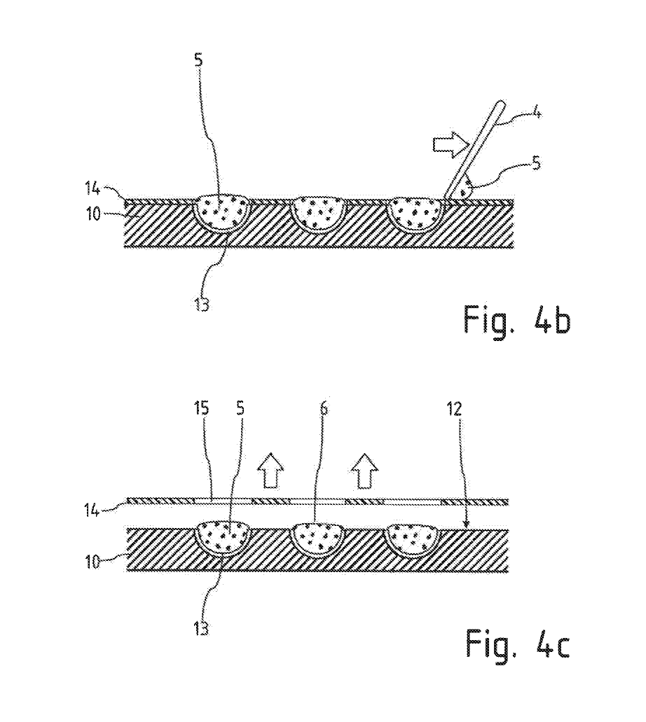

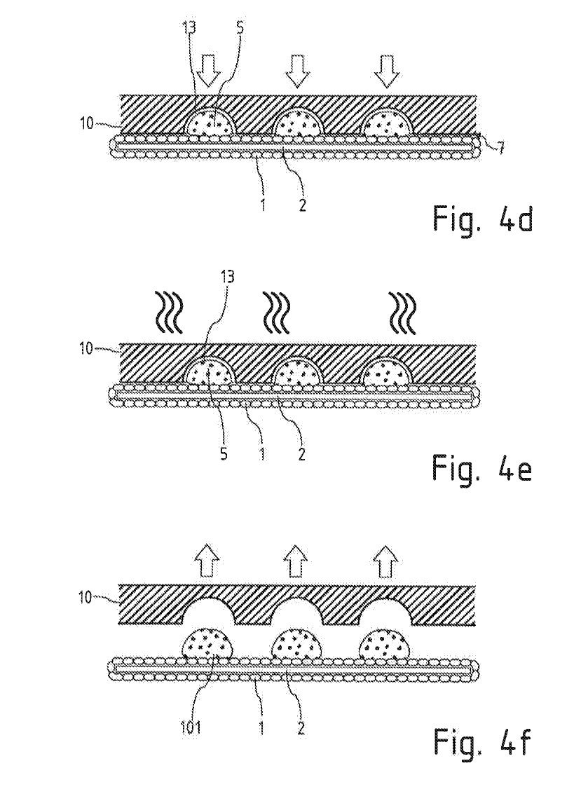

FIG. 4-a-4-f: The production of protector elements in various stages, each in a cross-sectional View;

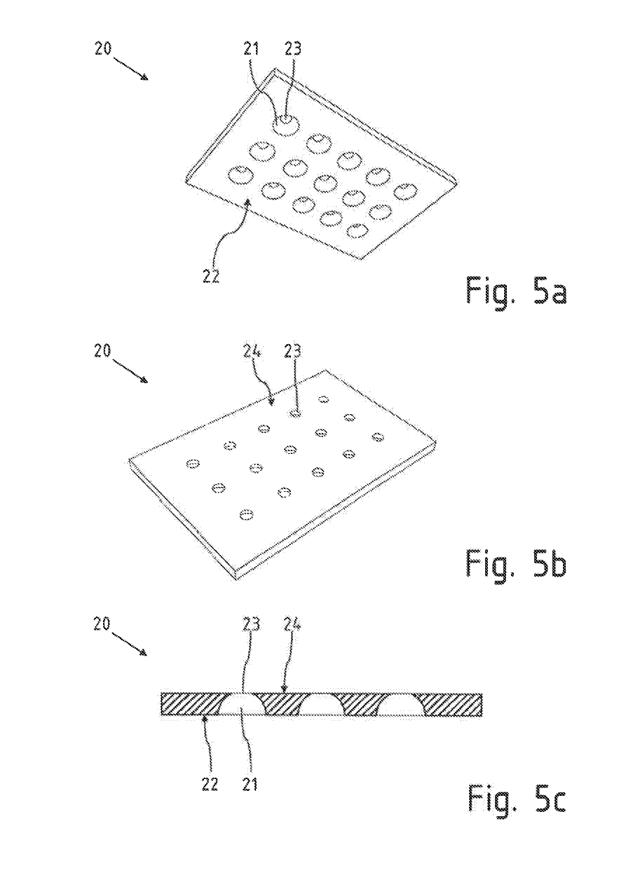

FIG. 5-a, 5-b: A molding plate in accordance with a second embodiment from below and from above, each in a perspective view;

FIG. 5-c: The molding plate in accordance with FIG. 5-a, 5-b, in a cross-sectional view;

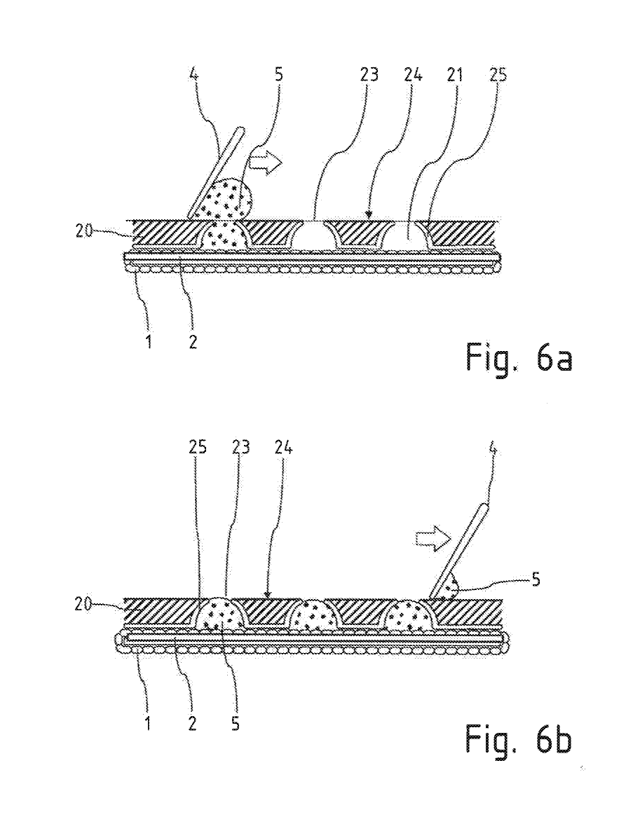

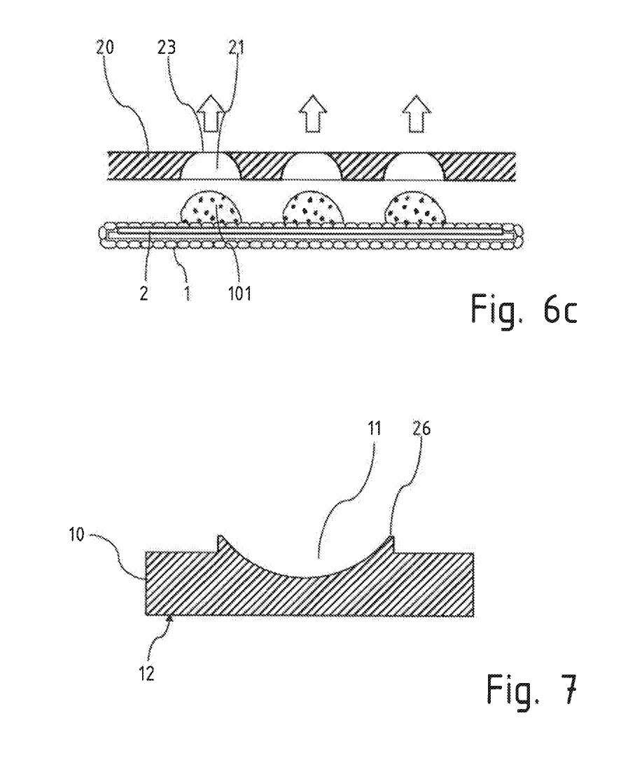

FIG. 6-a-6-f: The production of protector elements in various stages, each in a cross-sectional view; and:

FIG. 7: An embodiment of the molding plate in accordance with FIG. 3-b.

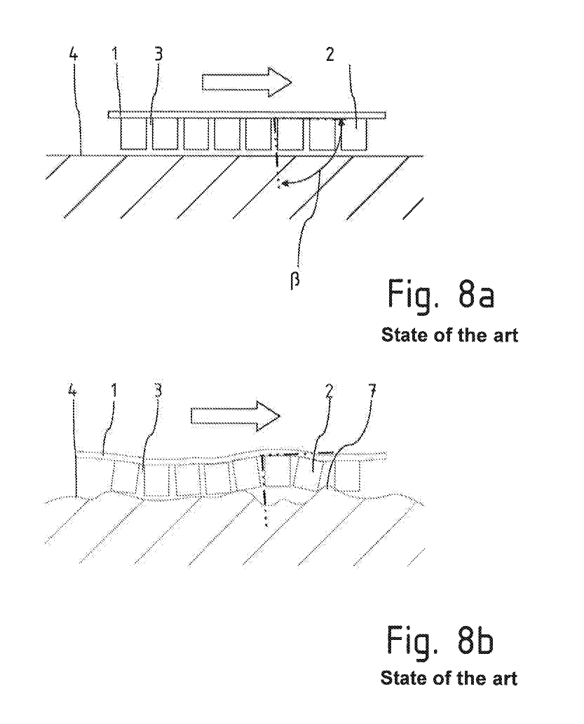

FIG. 8-a, 8-b: A clothing item provided with protector elements in accordance with the state of the art, in a lateral cross-sectional view;

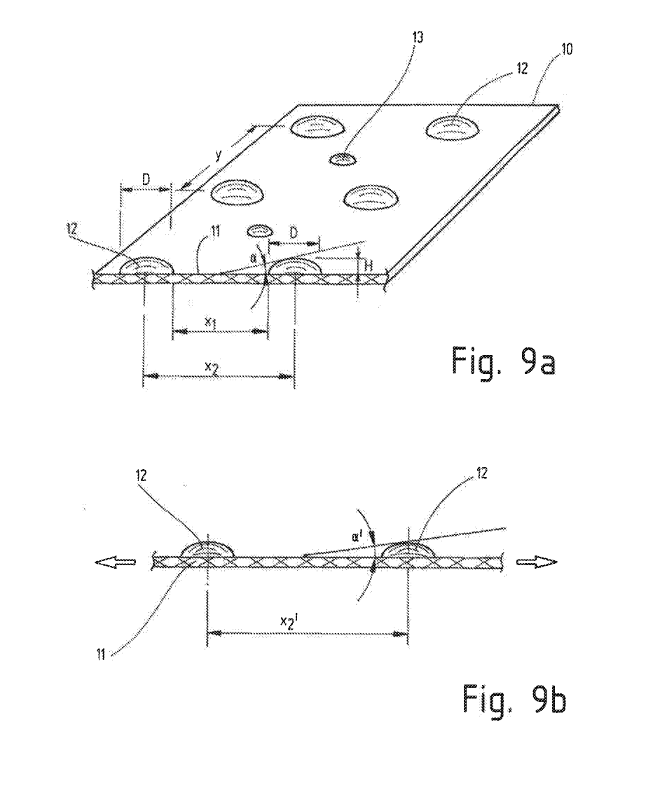

FIG. 9-a: An unexpanded section of a clothing item in accordance with the invention, in a perspective view;

FIG. 9-b: An expanded section of the clothing item, in a lateral cross-sectional view;

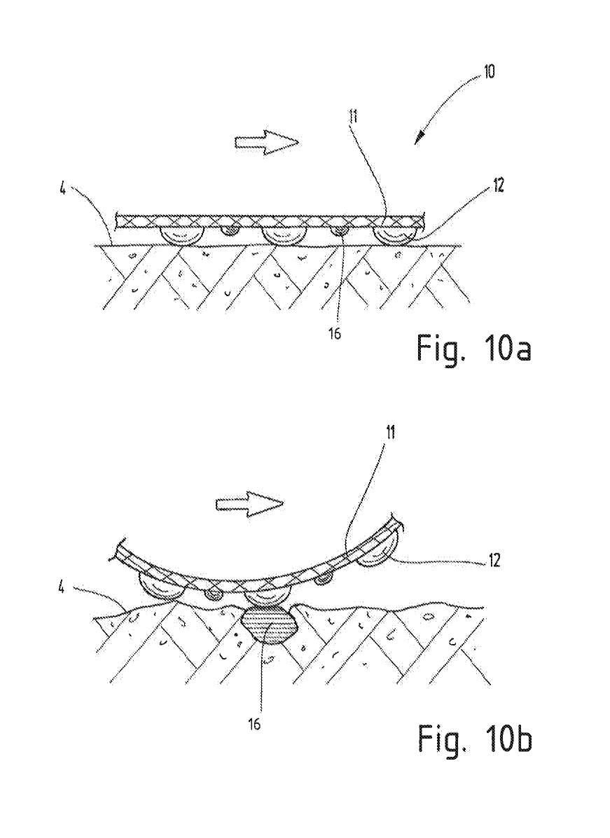

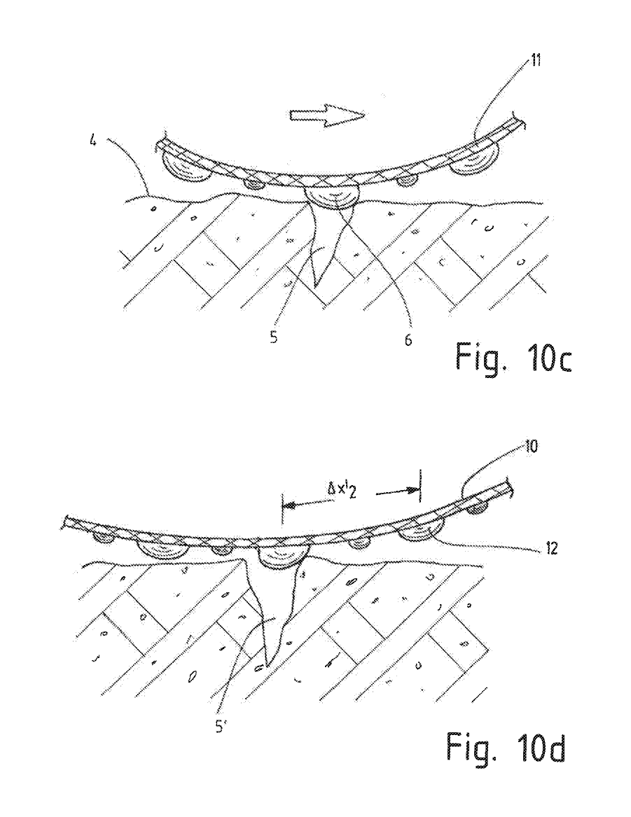

FIG. 10-a-10-d The functional principle of the clothing item in accordance with following a crash, each in schematic lateral view.

FIG. 1 depicts a two-part suit 100 for bicycle racing. A first clothing item is designed as a top part 110. The particularly endangered areas are located on the shoulder, as well as laterally on the torso, in the shoulder area, an abrasion protection zone 111 is provided with specific sizes of protector elements 101. A second abrasion protection zone 112 with protector elements of medium size proceeds along the arms. In a third abrasion protection zone 113, smaller protector elements are applied to the back of the arm and to the inside of the arm, which are less endangered upon bicycling. Abrasion protection zones 114 are also designed in the area of the back and the hips.

The top part 110 is supplemented by leg units 120, on which the abrasion protection zones 121, 122, 123 are likewise provided and, specifically so, particularly on the exteriors of the legs and in the area of the buttocks.

In the combination of both clothing items 110, 120, a continuous abrasion protection zone consequently extends from the area of the lower leg through the knee and the exterior of the thigh, the pelvis, and the buttocks, up to the rear of the body and up to the shoulder.

The front of the body, on the other hand, can be kept substantially free of abrasion protection zones since, during bicycling, a fall directed precisely forward is somewhat improbable and, because of the typical posture, a lateral tilting away to one side of the body or the other occurs during a crash.

FIG. 8-a depicts, in a schematic lateral cross-sectional view, a clothing item 1 with protector elements 2 designed in accordance with the state of the art. The gap 3 between the adjacent protector elements 2 is small, so that the so-called sliding angle β, at almost 90°, is very large. In the ideal case, the . . . clothing item 1 protected in such a way also slides over the road surface 4 and offers a protection against abrasion injuries.

In the actual case, however, the road surface is rough and has irregularities or cracks, which are indicated in FIG. 8-b. The clothing item 1, which is known from the state of the art, remains, in this case, caught with the edges of its protector elements 2 on peaks of roughness, so that a failure of the protector elements 2 or an abrupt stoppage comes about.

A section of a clothing item 10 designed in accordance with the invention is depicted in FIG. 9-a and, specifically so, a textile section 11 in the unexpanded condition which is provided with several protector elements 12, both in the one direction, referred to as x₁, x₂, as well as also in the y-coordinate proceeding perpendicularly to the same. In addition to the larger protector elements 12, which are arranged, in the embodiment depicted, in a regular grid, additional smaller protector elements 13 are arranged in the center. The larger protector elements 12 have a diameter D of 3 to 6 mm. The smaller protector elements 13 have a diameter d of 2 to 4 mm. In the unexpanded condition, a grid spacing x₂, which is approximately twice that of the diameter D is provided and, at the same time, the protector elements 12 have a height H, which corresponds to 0.5 to 0.1 times the diameter D. In this way, a tangent results, which is attached centrally between similar protector elements 12 and is in contact with the protector elements 12. This angle is designated as a sliding angle α, which amounts to at least less than 45°, preferably 30′ and less.

FIG. 9-b once again depicts the fabric section 11 in the expanded condition. The grid spacing x₂′ of the protector elements 12 is enlarged here by at least 20%. Through the unchanged geometry of the protector elements 12 itself, the sliding angle α′ drops because of the stretching, so that the angle is reduced just simply from the prestressing upon putting the clothing item on, and the sliding on peaks of roughness and foreign bodies is thereby improved.

FIG. 10-a to 10-c depict a sliding process similar to the representation of the state of the art in FIGS. 1-a and 1-b. At the bottom, a road surface 4 is depicted and, above that, the clothing item 10 is depicted with the protector elements 12, 13 upon a sliding movement proceeding from left to . . . right. The preferred embodiment of the clothing item 10 is depicted with at least two different size levels of protector elements 12, 13.

FIG. 10-a again corresponds to an idealized assumption in which the person crashing slides along a road surface that is smooth in relation to the protector elements 12, 13. An abrasion only thereby comes about in the contact surface between the road surface 4 and the higher protector elements 12. If individual protector elements 12 should, despite their very great hardness, be worn down upon a longer sliding path, an additional protection is achieved through the smaller protector elements 13,

FIG. 10-b depicts a representation more closely approximating the real situations. Because of the curvature of the body surface, individual protector elements are highly exposed, so that even the textile areas exposed between them are pressed onto the road surface, for which purpose an additional row of protector elements 13 with smaller size is in turn used in the preferred embodiment. Because of the slight sliding angle and the spherical segment shape of the protector elements 12 in the representation in accordance with FIG. 3-b, the middle element slides over a small rock 6 and above rough features of the road surface without the textile base coming into contact with the road surface.

A road surface with a sharp-edged crack 5 is depicted in FIG. 10-c. The middle protector element 12 is held back by the edge of the crack. As the detail FIG. 3-d depicts, an over-stretching of the fabric 11 in the area marked then occurs because of the present residual elasticity in the textile base 11, so that the original grid spacing is enlarged to a size x₂′. Because of its surfaces and dome-shaped formation, however, the protector element 12 does not penetrate deeply into the crack 5 and is, finally, further guided by the person sliding and by the restoration, brought about by the elastic fabric 11, back to the starting position.

A textile backing layer in the form of a circular knit tube 1 is used for the production of the protector elements 101. This is produced in the manner as known per se. For the formation of the hose 120 depicted in FIG. 1, for example, the width of the circular knit tube 1 is coordinated with the upper body circumference of the wearer. The legs can be configured through a later cutting out of the lower part of the tube.

In a circular knit tube 1 laid flat—as depicted in FIG. 2—, a support plate 2 is moved forward in order to create a hard base and the circular knit tube can be easy to fix. Only the entire unit of circular knit tube 1 and support plate 2 needs to be fixed, without the textile having to be stretched in any other way. In order to remain stable under the effect of heat, the support plate 2 should consist of metal or other heat-resistant material.

A molding plate 10, which is depicted schematically in FIG. 3-a, is used for the production of the many relatively small protector elements 101 in the clothing items 110, 120 depicted in FIG. 1. For the purpose of clarity, only a few form cavities 11 are depicted in enlarged form on a surface 12, both here as well as in the following figures. The diameter of the form cavities 12 actually amounts to approximately 2 to 6 mm. The depth of the form cavities 12 corresponds to approximately half diameter.

The uniformly grid-shaped arrangement of the cavities is also only to be understood as being by way of example, because it has been proven to be advantageous to provide a disordered, anisotropic distribution of the protector elements on the clothing item, in order to prevent longer cracking lines.

Furthermore, smaller cavities can also be provided with large base diameters within an arrangement of cavities. The interposing of small protector elements offers an additional protection precisely then if a fabric or knitted fabric that is locally strongly overstretched should lie free between the larger protector elements.

As the cross-sectional view of the molding plate 10 in FIG. 3-b shows, the form cavities 11 are only opened toward the surface 12. The molding plate 10 preferably consists of aluminum, which remains sufficiently stable under the influence of heat and, upon manual production, can be handled well because of its low weight.

The surface 12 of the molding plate 10 is, as shown in FIG. 7, thereby milled and lowered to the edge elevation 26 of the form cavities 11. The depth of the reduction thereby corresponds to the thickness of the auxiliary blade plate described in further detail in FIG. 3-c. With the auxiliary blade plate placed on, the surface 12 is then even with the edge elevation 26.

FIG. 3-c depicts an auxiliary blade plate 14, which has openings 15. The size and the arrangement of the openings 15 correspond to the openings of the form cavities 11 in the molding plate 10.

A first embodiment of the manufacturing process in accordance with the invention is explained in further detail by means of the sequence illustrated in FIGS. 4-a to 4-f:

In FIG. 4-a, the molding plate 10 is already prepared, since the form cavities 11 have already been treated with a separating agent 13. Furthermore, the auxiliary blade plate 14 is applied to the surface 12. In the left form cavity 11, coating mass 5 has already been moved in by means of a blade 4.

In FIG. 4-b, all form cavities 11 are filled with coating mass 5. Excess coating mass 5 is removed by means of the blade 4.

As depicted in FIG. 4-c, the auxiliary blade plate 14 is subsequently drawn upwardly by the molding plate 10.

The correspondingly prepared molding plate 10 is now, as depicted in FIG. 4-d, reversed and applied with the openings downwardly towards the circular knit tube 1. By pressing the molding plate 10 onto the circular knit tube 1, the coating mass 5 is pressed into the knitted fabric.

FIG. 4-e depicts the hardening of the coating mass 5 by means of heat treatment. The coating mass 5 pressed into the knitted fabric enters into an unlosable, solid connection with the knitted fabric.

After the hardening, the molding plate 10 of the circular knit tube 1 only needs to be removed, corresponding to FIG. 4-f. The coating mass 5 now remains in the form of solid protector elements 1001 on the textile base layer. The support plate 2 then only needs to be removed in order to conclude the production. The circular knit tube 1 is subsequently further processed into a clothing item in the known manner.

FIG. 5-a depicts an additional molding plate 20, which has form cavities 21 that are designed concave and, in particular, shaped as spherical segments and which open, at the broad base, into a first surface 22. In tile upper area of their bulges, the form cavities 21 have an additional narrow opening 23. Only a few, enlarged form cavities are also depicted in the embodiment of the molding plate 20 depicted for the sake of better representation.

FIG. 5-b depicts the opposing surface 24 of the molding plate 20 with the narrow openings 23.

The cross-sectional view in FIG. 5-c clarifies the position of the form cavities 21. A slight deviation of the ideal form of a hemisphere represented by the dotted lines arises through the openings 23.

A second embodiment of a manufacturing process in accordance with the invention upon use of the molding plate 20 is explained by means of the sequence in FIGS. 6-a to 6-c:

in FIG. 6-a, the molding plate 20 is already applied to the circular knit tube 1 supported by the support plate 2. The form cavities 21 have first been treated with a separating agent 25. The coating mass 5 is raked into the form cavities 21 by means of a blade 4 and, specifically so, starting from the surface 24 and through the narrow openings 23 in the specific upper side of the form cavities 21.

In accordance with FIG. 6-b, all form cavities 21 have been filled and excess coating mass 5 has been removed by the blade 4. The hardening of the coating mass can then be carried out through the fact that the unit is removed from a circular knit tube 1 and a molding plate 20, for example, and into a hardening oven.

As FIG. 6-c shows, the molding plate 20 is drawn out after hardening out, so that the hardened coating mass remains, in each form cavity, as a protector element 101 on the circular knit tube 1.

The present invention is not restricted in its design to the above-stated preferred embodiments. Rather, a number of variants are conceivable, which also make use of the solution depicted as well as fundamentally different designs, so that the edge elevation 26 can be configured in different ways, for example.

1. A textile clothing item (10, 110, 120) with at least one abrasion protection zone (111, 112, 113, 121, 122, 123) provided with protector elements (12, 30), in which a large number of protector elements (12, 13) are applied at a distance from one another on a textile base (11, 21), whereby the protector elements (12, 13) consist of a polymer matrix with embedded abrasion-resistant particles,
Characterized in that,
At least one protection zone is designed as an abrasion protection zone (111, 112, 113, 114, 211, 212, 213), in which the textile base (11) is formed from a knitted fabric that is expandable by at least 20%,
Whereby the protector elements (12, 13) are designed in a curved shape and are anchored with a broad base on the textile base (11) and taper radially outwardly,
Whereby the height of the protector elements measured between one summit and the base (12, 13) amounts to 0.1 times to 0.5 times its surface diameter at the base,
That the sliding angle defined as a tangential angle between one free surface of the base and an adjacent protector element is less than 45°, particularly less than 30°.

2. Clothing item in accordance with claim 1, characterized in that, the protector elements (12, 13) are shaped as spherical segments or have a lenticular form.

3. Clothing item in accordance with claim 1 or 2, characterized in that, different sizes of protector elements (12, 13) are applied, whereby at least one small protector element (13) each is arranged between adjacent larger protector elements (2).

4. Clothing item in accordance with one of the claims 1 to 3, characterized in that, the protector elements consist of boron carbide and of a hardenable polymer additive.

5. Clothing item in accordance with one of the claims 1 to 4, characterized in that, the sliding angle defined as a tangential angle between one free surface of the base and an adjacent protector element is less than 45°, particularly less than 30°.

6. Clothing item in accordance with one of the claims 1 to 5, characterized in that, the distance of the protector elements (12, 13) from one another in the pre-extended support condition of the textile base (11) amounts to at least 1.0 times the average surface diameter of the base (11) and, in the expanded condition, a maximum of 3.0 times the average surface diameter of the base (11).

7. Clothing item in accordance with one of the claims 1 to 6, characterized in that, the diameter of the protector elements (12, 13) of the base (11) amounts to 2 mm to 6 mm.

8. Clothing item in accordance with one of the claims 1 to 7, characterized in that, the diameter of the larger protector elements (12) of the base (11) amounts to 4 mm to 6 mm and the diameter of the smaller protector elements (13) of the base (11) amounts to 2 mm to 4 mm.

9. Process for the production of a textile clothing item (100) with at least one abrasion protection zone (110) provided with protector elements (101) in accordance with one of the preceding claims, with at least the following steps:
1) Provision of a textile backing layer (1);
2) Provision of a pasty, hardenable coating material (5);
3) Application of a large number of portions of the coating material (5) on a surface of the backing layer for the formation of the protector elements (101), whereby the portions of the coating material (5) are arranged on the surface in such a way that the portions . . . do not overlap and that only a portion of the surface of the backing layer is covered by the coating material (5);
4) Hardening of the coating material (5) for the formation of a large number of hard protector elements (101) on the backing layer;
Characterized in that:
a) That the textile backing layer is expandable and is provided in the form of a textile tube open on both sides (1), and that, before the application of the coating material (5), a support element (2) is introduced into the tube (1), by means of which the tube (1) is pre-extended and is stretched wrinkle-free in the abrasion protection zones provided;
b) That at least one form element (10, 20), which contains a large number of concave form cavities (11, 21) for the formation of the protector elements (101), which are filled with the pasty coating mass (5), is used, and that the form element (10, 20) is, with the surface (12, 22) provided with the openings of the form cavities (11, 21), applied to the tube (1) supported with the support plate (2);
c) That the coating mass (5) is hardened, and:
d) That the form element (10, 20) is removed from the textile tube (1):

10. Process in accordance with claim 9, characterized by the following additional steps in the step b):
b-1) Use of a flat molding plate (10) as a form element and placement of a thin auxiliary blade plate (14) on the molding plate (10), whereby the thickness of the auxiliary blade plate (14) amounts to less than one fifth of the depth of the form cavities (11) and whereby the auxiliary blade plate (14) is provided with recesses (15), the pattern of holes of which is in agreement with the opening cross-sections of the form cavities (11) on the surface (12) of the molding plate (10);
b-2) Introduction of the pasty coating material (5) through the openings of the auxiliary blade plate (14) and into the form cavities (11) of the molding plate (10);
b-3) Wiping of the surface of the auxiliary blade plate (14); and:
b-4) Removal of the auxiliary blade plate (14) from the molding plate (10).
b-5) Placement of the molding plate (10) with its surface (12) provided with the openings of the form cavities (11) onto the tube (1),

11. Process in accordance with claim 10, characterized in that, two molding plates (10) provided with an auxiliary blade plate (14) and filled in the form cavities (11) with coating mass (5) are both used, which molding plates are applied on opposing sides of the tube (1) supported with the support plate (2).

12. Process in accordance with claim 9, characterized by the following additional steps in step b):
b-1) Provision of at least one form element (20) that contains a large number of concave form cavities (21) for the formation of the protector elements (101), whereby the form cavities (21) each have a broad base on the surface (22) to be oriented to the textile backing layer (1) and a tapered opening (23) on the opposing surface (24);
b-2) Placement of the form element (20) with the surface (22) provided with the broad openings of the form cavities (21) on the circular knit tube (1) supported by the support element;
b-3) Introduction of the pasty coating material (5) through the narrow openings (23) of the form element (20) and into the form cavities (21);
b-4) Wiping of the surface (24) provided with the narrow openings (23) of the form cavities (21).

13. Process in accordance with one of the preceding claims 9 to 12, characterized in that, the textile backing layer is formed by a three-dimensional knitted fabric and the tube (1) is a circular knit tube.

14. Process in accordance with one of the preceding claims 9 to 13, characterized in that, at least the form cavities (11, 21) in the form element (10, 20) are provided with a separating agent (13) before the application of the pasty coating mass (5).

15. Process in accordance with one of the preceding claims 9 to 14, characterized in that, the tube (1) has an extensibility of at least 20% to 40%.
